(19) United States
(12) Patent Application Publication
(10) Pub. No.: US 2008/0072725 A1
(43) Pub. Date: Mar. 27, 2008

(54) VACUUM PRESSURE WORK PIECE HOLDING DEVICE FOR A SAW

(76) Inventor: David CROWTHER, Parksville (CA)

Correspondence Address: DAVIS BUJOLD & Daniels, P.L.L.C., 112 PLEASANT STREET, CONCORD, NH, 03301, US

(21) Appl. No.: 11/860,804

(22) Filed: Sep. 25, 2007

(30) Foreign Application Priority Data
Sep. 25, 2006 (CA) 2 561 465

(51) Int. Cl. B26D 7/02

(52) U.S. Cl. 83/451

(57) ABSTRACT

A vacuum pressure work piece holding device for a saw includes an endless loop conveyor having a first face, a second face and air flow openings which extend between the first face and the second face. There is means provided for applying a vacuum to the second face of the endless loop conveyor, such that work pieces are held by vacuum pressure against the first face. A drive assembly creates movement of the endless loop conveyor. A saw blade is positioned in parallel spaced relation to the first face, such that movement of the endless loop conveyor brings the work pieces held by vacuum pressure against the first face into engagement with the saw blade.

### FIELD OF THE INVENTION

The present invention relates to a vacuum pressure work piece holding device for a saw and, in particular, a vacuum work piece holding device for use in the sawing of wooden shingle blanks.

### BACKGROUND OF THE INVENTION

Vacuum holding devices per se are known in the art. U.S. Pat. No. 5,385,184 (Mellor) discloses a vacuum holding device for a veneer slicer. U.S. Pat. No. 4,693,458 (Lewecke et al) discloses a vacuum holding device for clamping lumber during processing.

### SUMMARY OF THE INVENTION

According to the present invention there is provided a vacuum pressure work piece holding device for a saw, including an endless loop conveyor having a first face, a second face and air flow openings which extend between the first face and the second face. There is means provided for applying a vacuum to the second face of the endless loop conveyor, such that work pieces are held by vacuum pressure against the first face. A drive assembly creates movement of the endless loop conveyor. A saw blade is positioned adjacent to the first face, such that movement of the endless loop conveyor brings the work pieces held by vacuum pressure against the first face into engagement with the saw blade.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1 is a top plan view of a vacuum pressure work piece holding device.

FIG. 2 is a side elevation view of the vacuum pressure work piece holding device.

FIG. 3 is a side elevation view of a vacuum pressure work piece holding device with the saw perpendicular to the endless loop conveyor.

### DETAILED DESCRIPTION OF THE PREFERRED EMBODIMENT

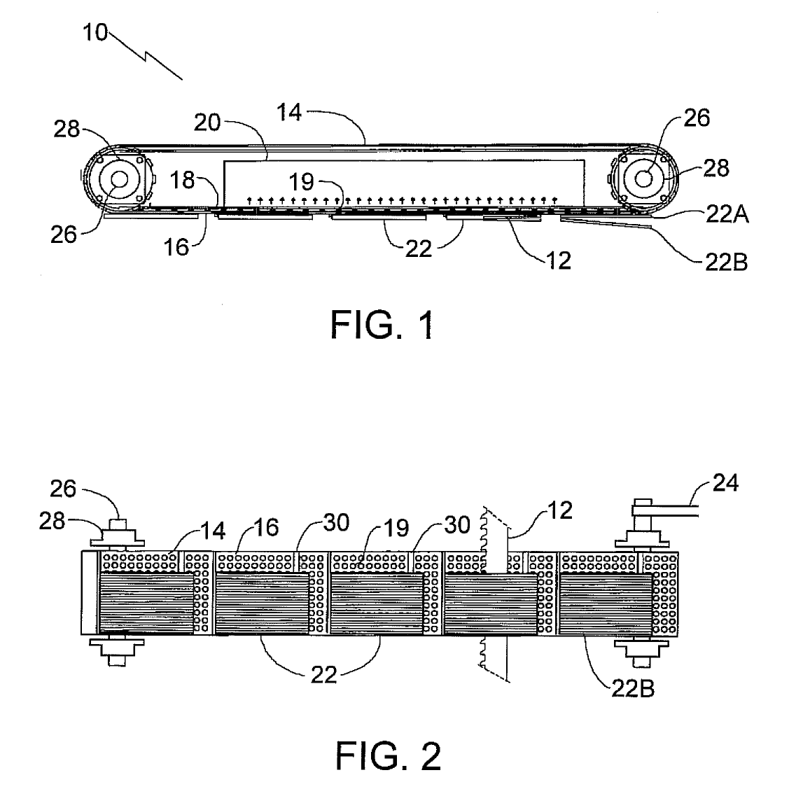

The preferred embodiment, a vacuum pressure work piece holding device. generally identified by reference numeral 10, will now be described with reference to FIG. 1 and 2.

Structure and Relationship of Parts:

Referring to FIG. 1, vacuum pressure work piece holding device 10 for a saw 12, such as a band saw, includes an endless loop conveyor 14 having a first face 16, a second face 18 and air flow openings 19 which extend between first face 16 and second face 18. A vacuum box 20 is used as means to applying a vacuum to second face 18 of endless loop conveyor 14, such that work pieces 22, such as wooden blanks that as are used as shingles, are held by vacuum pressure against first face 16. Referring to FIG. 2, a drive assembly represented by drive assembly belt 24 causes endless loop conveyor 14 to move over shafts 26 which turn within bearings 28. It will be understood that other vacuum means and drive assemblies may be used. Referring again to FIG. 1, saw blade 12 is shown to be positioned in parallel spaced relation to first face 16, such that movement of endless loop conveyor 14 brings work pieces 22 held by vacuum pressure against first face 16 into engagement with saw blade 12. The distance of saw blade 12 from endless conveyor 14 may be adjusted depending on the thickness of work pieces 22 and the desired results. As depicted, first face 16 and saw blade 12 are both in a vertical orientation. Referring to FIG. 2, for cutting shingles, endless conveyor 14 may also have spacers 30 to provide the appropriate angle or offset to split work pieces 22 for use as shingles.

Operation:

The use and operation of holding device 10 described above with reference to FIG. 1 and 2 will now be discussed. Referring to FIG. 2, endless conveyor 14 is caused to move by activating drive assembly belt 24. Band saw 12 is turned on to be able to cut work pieces 22, and referring to FIG. 1, vacuum box 20 is also turned on. Work pieces 22 are then placed against first face 16 of endless conveyor 14, which are held in position by the vacuum pressure applied by vacuum box 20. Endless conveyor 14 then causes work pieces 22 to come into contact with saw 12, such that saw blade 12 cuts work piece 22 into two parts, indicated as 22A and 22B. The distance of saw 12 from endless conveyor 14 may be adjusted such that work pieces 22A and 22B are similar in width.

While shingles has been used as the example, it will be understood that the above device may be used to cut other types of work pieces 22, such as planks, boards, unfinished wood, etc. in various ways The only requirement is that work piece 22 to be cut is able to be held against endless loop conveyor 14 by vacuum box 20. Alternatively, different types of work pieces may require some slight modifications to vacuum box 20 and/or endless loop conveyor 14 that will be apparent to those skilled in the art.

Variations:

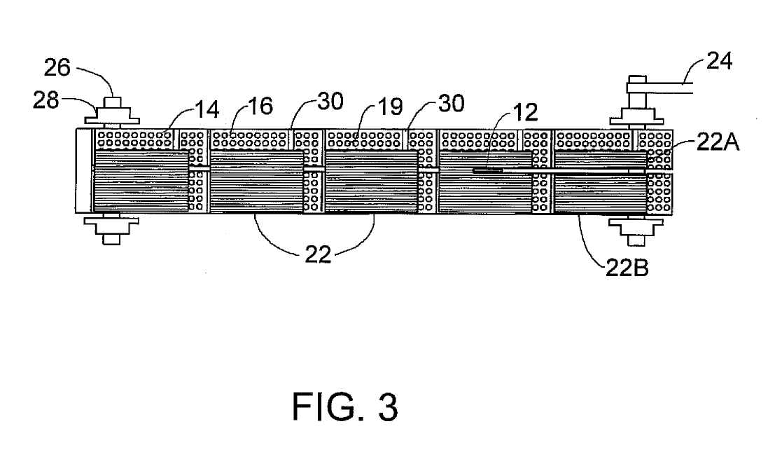

Referring to FIG. 3, the relationship of saw blade 12 relative to first face 16 may be adjusted, such that instead of being parallel, saw blade 12 may be perpendicular or at an intermediate angle to cut work pieces 22 in sections along their length or width instead of along their thickness, and in order to produce an angled edge. It will be understood that some modifications may be necessary in some cases. For example, in FIG. 3, endless loop conveyor 14 has been split to accommodate saw blade 12.

A band saw has been chosen for illustration. It will be understood that vacuum holding device 10 could be used with radial saws or other types of saws could be used.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope of the invention as hereinafter defined in the Claims.

What is claimed is:

1. A vacuum pressure work piece holding device for a saw, comprising:
an endless loop conveyor having a first face, a second face and air flow openings which extend between the first face and the second face;
means for applying a vacuum to the second face of the endless loop conveyor, such that work pieces are held by vacuum pressure against the first face;
a drive assembly for creating movement of the endless loop conveyor;
a saw blade positioned adjacent to the first face, such that movement of the endless loop conveyor brings the work pieces held by vacuum pressure against the first face into engagement with the saw blade.

2. The device as defined in claim 1, wherein the first face and the saw blade are both in a vertical orientation.

3. The device as defined in claim 1, wherein the work pieces are wooden blanks.

4. The device as defined in claim 3, wherein the wooden blanks are wooden shingle blanks.

5. The device as defined in claim 1, wherein the saw is a band saw.

6. The device as defined in claim 1, wherein the saw blade is positioned at an angle to the first face of the endless loop conveyor.

7. The device as defined in claim 1, wherein the saw blade is positioned in parallel spaced relation to the first face of the endless loop conveyor.

8. The device as defined in claim 1, wherein the saw blade is positioned perpendicular to the first face of the endless loop conveyor.
